(19) United States
(12) Patent Application Publication
(10) Pub. No.: US 2009/0063741 A1
(43) Pub. Date: Mar. 5, 2009

(54) METHOD FOR DYNAMICALLY ALLOCATING LINK WIDTH OF RISER CARD

(75) Inventor: Ying-Chih Lu, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 11/936,261

(22) Filed: Nov. 7, 2007

(30) Foreign Application Priority Data
Aug. 29, 2007 (TW) 96132008

(51) Int. Cl. G06F 13/00

(52) U.S. Cl. 710/301

(57) ABSTRACT

A method for dynamically allocating link width of a riser card is disclosed. The method is suitable for a system including a riser card. In the present method, the number and the positions of cards inserted in the slots and functioning normally are detected so as to decide the link widths allocated for each of the cards. Next, a link width retraining procedure is executed so as to provide a proper link width for each the card to use. In this way, the present invention is able to achieve the optimization of allocating link widths without being limited by the types and the number of the cards disposed on the riser card, which is advantageous in saving the design cost of the riser card and enhancing the convenience to use and handle with the riser card.

### CROSS-REFERENCE TO RELATED APPLICATION

This application claims the priority benefit of Taiwan application serial no. 96132008, filed Aug. 29, 2007. All disclosure of the Taiwan application is incorporated herein by reference.

### BACKGROUND OF THE INVENTION

1. Field of the Invention

The present invention generally relates to an allocation method of a logic circuit, and more particularly, to a method for dynamically allocating link width of a riser card.

2. Description of Related Art

A riser card is an interface expansion card commonly used in a computer system installed in a space-saving case, for example, a mini quasi-system or a flat server. Since the critical space limitation, the motherboard of the above-mentioned computer system has a limited space available for disposing peripheral component interconnect (PCI) slots. Once a customer needs to use more PCI cards, the above-mentioned riser card is a choice where a PCI slot is expanded to two or more slots by means of an ‘one connecting multiple’ scheme.

Note that every expansion slot on a motherboard requires to setup an interrupt request (IRQ) therefore, while the number of configured slots on a riser card depends on a link width that the chipset of the system is able to support. In terms of a chipset capable of supporting x16 link width, there are four designed types of riser cards available:

riser card 0: configured with four peripheral component interconnect express slots (PCI-E slots) with x4 link width for each the slot;

riser card 1: configured with two PCI-E slots with x4 link width and one PCI-E slot with x8 link width;

riser card 2: configured with two PCI-E slots with x8 link width;

riser card 3: configured with one PCI-E slot with x16 link width.

FIG. 1 is a system block diagram installed with a conventional riser card having two PCI-E slots. Referring to FIG. 1, a system 100 includes a control chip 110, a riser card 120 and a south-bridge chip 130, wherein the control chip 110 may be a north-bridge chip capable of supporting x16 link width and dividing the x16 link width into four x4 link widths which are controlled by a PCI-E bridge 0, a PCI-E bridge 1, a PCI-E bridge 2 and a PCI-E bridge 3, respectively. After the riser card 120 is inserted into the system 100, because the riser card 120 is only configured with a PCI-E slot 0 and a PCI-E slot 1, the control chip 110 would equally divide the link width thereof into two portions allocated to the PCI-E slot 0 and the PCI-E slot 1, respectively. Thus, the usable link widths for the PCI-E slot 0 and the PCI-E slot 1 are both x8 link width. The riser card 120 is disposed with a bus controller 123 which communicates with a bus controller 131 inside the south-bridge chip 130 by means of inter integrated circuit (I2C) protocol so as to deliver back the identification code (ID code) of the riser card 120 to the control chip 110 through the south-bridge chip 130. Once the control chip 110 receives the ID code, the control chip 110 is able to identify the type of the riser card 120 so as to arrange a bridge for a corresponding PCI-E slot on the riser card 120 to use, wherein the ID code is provided by three general purpose input pins (GPI pins) GPI0, GPI1 and GPI2, and the ID code of the riser card 120 is, for example, a binary number of 010.

A customer can chose a different riser card to suit PCI-E card configuration according to the application thereof. For example, if only one x16 PCI-E is needed, a riser card 3 must be chosen to provide a sufficient link width (x16); in case a riser card 2 is chosen, since a PCI-E slot of a riser card 2 is able to support x8 link width which is smaller than the required x16, the inserted PCI-E card would reduce its link width to 8 from 16 or functionally fail. It can be seen that a system designer must provide various riser cards to customers, which brings on inconvenience to handle riser cards and an increasing design cost of riser card.

### SUMMARY OF THE INVENTION

Accordingly, the present invention is directed to a method for dynamically allocating link width of a riser card, by which the type and number of the cards inserted in the slots on the riser card are detected, following by allocating each card with a usable link width so as to make one riser card suitable for adapting a plurality of cards in different types and numbers, thereby saving the design cost.

To achieve the above-mentioned or other objectives, the present invention provides a method for dynamically allocating link width of a riser card suitable for a system including one riser card, wherein the riser card includes a plurality of slots to accept a plurality of cards to be inserted therein. The method includes following steps: a. detecting the number and the positions of cards inserted in the slots and functioning normally; b. setting a configuration for the control chip of the system according to the number and positions of the cards; c. setting link widths to be allocated for each the card to use according to the configuration of the control chip; d. executing a retraining procedure of link widths so as to allocate each card with a link width.

In an embodiment of the present invention, the above-mentioned configuration of the control chip of the system includes one of one card, two cards, three cards and four cards, and the link width available for each card to use includes one of x1 link width, x4 link width, x8 link width and x16 link width.

In an embodiment of the present invention, the above-mentioned step a. includes presetting the configuration to be four cards, the link width allocated for each card to use is set to x4 link width, then executing a retraining procedure of link widths and finally obtaining the number and the positions of the cards inserted in each the slots and functioning normally according to the retraining result of the retraining procedure of link widths.

In an embodiment of the present invention, the above-mentioned retraining result is recorded in the status registers of a plurality of bridges of the control chip, and the retraining result includes whether or not a card is inserted in each slot of each the bridge, whether or not the inserted card functions normally and the link width of each the card.

In an embodiment of the present invention, if the configuration is set to one card, the link width allocated for the card to use is set to one x16 link width; if the configuration is set to two cards, the link width allocated for each of the card to use is set to two x8 link widths; if the configuration is set to three cards, the link width allocated for each the card to use is set to two x4 link widths and one x8 link width.

In an embodiment of the present invention, if the configuration is set to be three cards, after step d., the method further includes judging whether or not the retraining result of the link width retraining procedure is optimal; if not, modifying the link width allocated for each the card to use and re-executing a link width retraining procedure until the optimal retraining result is achieved.

In an embodiment of the present invention, if the configuration is set to be three cards, after step d., the method further includes recording the result of link width retraining, modifying the link width allocated to each the card for use, re-executing a link width retraining procedure, selecting the optimal retraining result and executing a link width retraining procedure to allocate a link width for each the card to use.

In an embodiment of the present invention, the step of setting a control chip configuration of a system includes setting the retraining register of the control chip to decide a proper configuration; the step of executing a link width retraining procedure includes setting the retraining register to start up a link width retraining procedure. In addition, after starting up a link width retraining procedure, the method for dynamically allocating link width of a riser card further includes delaying a preset time for waiting for completing the link width retraining procedure.

In an embodiment of the present invention, the step of setting link widths to be allocated for each the card to use according to the configuration of the control chip includes setting a plurality of pins of a logic circuit so as to connect a plurality of bridges of the control chip to each the slot through the logic circuit, thereby providing each the card with a link width for use.

In an embodiment of the present invention, the above-mentioned control chip is a north-bridge chip, and the above-mentioned card includes peripheral component interconnect express card (PCI-E card).

The present invention adopts an architecture for dynamically allocating link width of a riser card. By using the architecture, the present invention is able to allocate each card with a proper link width for use and achieve the optimal link width allocation according to the type and the number of the cards inserted in the riser card. In this way, the present invention is able to make one riser card suitable for adapting a plurality of cards in different types and numbers, thereby saving the design cost.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system block diagram installed with a conventional riser card having two PCI-E slots.

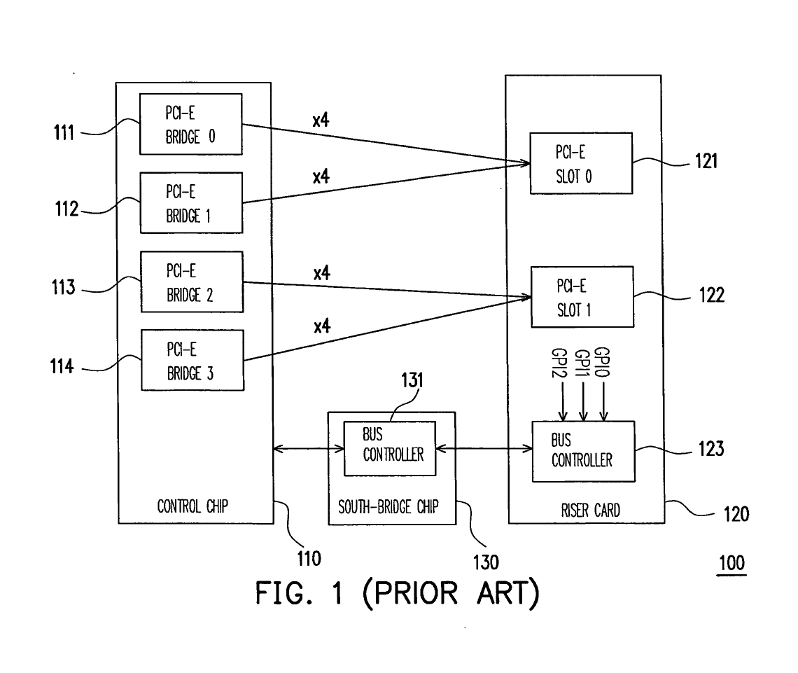

FIG. 2 is a block diagram of a system adopting the method for dynamically allocating link width of a riser card according to the first embodiment of the present invention.

FIG. 3 is a flowchart of the method for dynamically allocating link width of a riser card according to the second embodiment of the present invention.

FIG. 4 is a flowchart of the method for dynamically allocating link width of a riser card according to the third embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

General speaking, in the prior art, the number of the equipped slots on a riser card and the allocated link width of each the slot are fixed. Although such a manner is able to expand the function of a system, the expansion flexibility of the system is restricted too. For a real application, each customer has different demands, thus, a riser card may accept one, two even more cards to be inserted thereon. Confronting the above-mentioned problem, the optimal solution for allocating link width is to consider the type and the number of the cards disposed on a riser card for deciding the reasonable link width allocated to each slot, only in this way, the function expansion and the operation flexibility of a system can be properly compromised. The present invention is a method for dynamically allocating link width of a riser card developed from the above-mentioned consideration. Some embodiments of the present invention are depicted hereinafter to better understand the spirit of the present invention.

### The First Embodiment

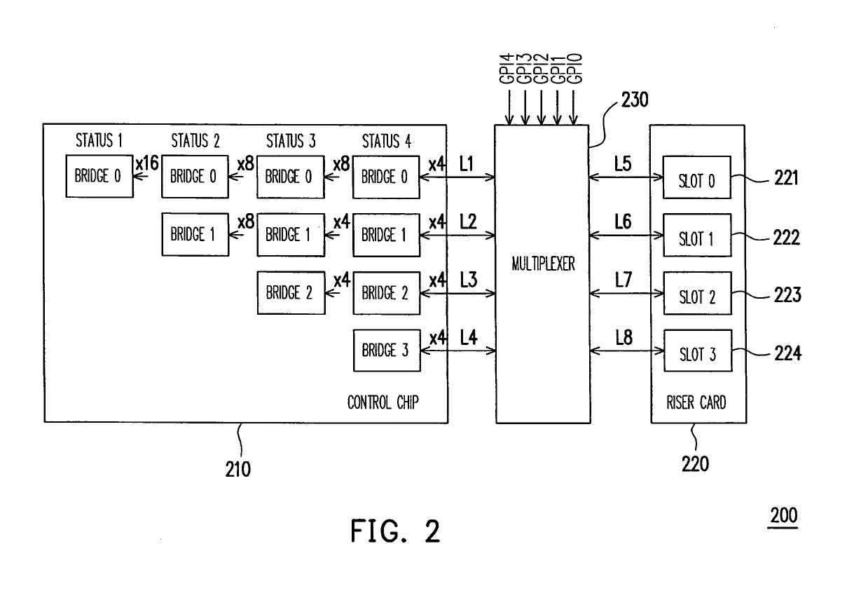

FIG. 2 is a block diagram of a system adopting the method for dynamically allocating link width of a riser card according to the first embodiment of the present invention. Referring to FIG. 2, a riser card 220 is inserted into a slot (not shown) on the motherboard of a system 200. Four slots are disposed on the riser card 220 (including a slot 0, a slot 1, a slot 2 and a slot 3) for accepting 1-4 cards to be inserted therein, wherein the slots are, for example, PCI-E slots and the cards are, for example, PCI-E cards, but the present invention is not limited to them.

Once the riser card 220 is installed on the system 200, the system 200 would set the configuration of a control chip 210, meanwhile the setting value corresponding to the configuration is written in a retraining register of the control chip 210, wherein the above-mentioned configuration includes one card, two cards, three cards or four cards, but the present invention is not limited to them.

If the configuration of the control chip 210 is set to be four cards, for example, a setting value of ‘04’ is needed to be written in the retraining register. After the control chip 210 is informed of the setting value, four bridges are assigned so as to allocate link widths for the slots on the riser card 220 to use.

In addition, the system 200 also makes the hardware logic circuit of a multiplexer 230 capable of supporting four x4 link width slots. In more detail, the general purpose output pins (GPO pins) of the hardware logic register in the super input/output control chip (SIO control chip) or the south-bridge chip of the system 200, and the general purpose input pins (GPI pins) of the multiplexer 230, i.e., GPI4, GPI3, GPI2, GPI1 and GPI0 are respectively written ‘0’, ‘1’, ‘1’, ‘1’ and ‘1’, five binary numbers so as to control the multiplexer 230 to adjust the hardware logic circuit. As a result, four bridges of the control chip 210 are correspondingly connected to four slots on the riser card 220.

In the end, a link width retraining procedure is started up by setting the retraining register of the control chip 210 (for example, ‘1’ is written as the fourth bit) so as to allocate a link width for each card to use, thereby obtaining the number and the positions of the inserted cards on the riser card 220. It can be seen, in the embodiment, for the configuration of four cards for the control chip 210, after performing a link width retraining procedure, each slot is allocated with x4 link width.

In association with the above-mentioned system, the present invention also provides a method for dynamically allocating link width of a riser card to run the system. Two embodiments of the method are depicted hereinafter.

### The Second Embodiment

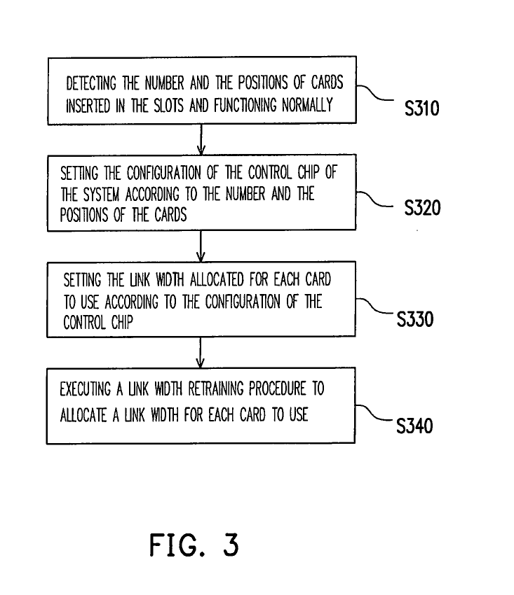

FIG. 3 is a flowchart of the method for dynamically allocating link width of a riser card according to the second embodiment of the present invention. Referring to FIG. 3, the embodiment is suitable for a system including one riser card, wherein the riser card includes a plurality of slots to accept a plurality of cards to be inserted therein. The above-mentioned slots are, for example, PCI-E slots and the cards are, for example, PCI-E cards, but the present invention is not limited to them.

Once the riser card is inserted on the motherboard of the system, after inserting the cards into the slots of the riser card and starting up the system, the system would detect the number and the positions of cards inserted in the slots and functioning normally (step S310), wherein the embodiment does not limit the slot number on the riser card and whether or not every slot accepts a card to be inserted therein (i.e. any slot is allowed to be inserted by a card or to be free of a card).

Next, a configuration for the control chip of the system is set according to the number and positions of the cards (step S320), wherein the configuration of the control chip includes one card, two cards, three cards or four cards and meanwhile the setting value corresponding to the configuration is written, for example, in a retraining register of the control chip.

Then, the hardware logic circuit in the multiplexer is set according to the set configuration so as to respectively connect the bridge circuit of the control chip to each the card (step S330), wherein the link width allocated for each card to use is, for example, x1 link width, x4 link width, x8 link width or x16 link width and the real allocated link width is determined by the detected number of the cards, but the embodiment is not limited to them.

Further, in a link width retraining procedure of the control chip, a value of ‘1’ is written, following by executing a link width retraining procedure (step S340). After delaying a preset time, the link width retraining procedure is completed and meanwhile the link width for each card to use is obtained.

In order to obtain the optimal result to allocate link widths, one more embodiment is depicted in the following.

### The Third Embodiment

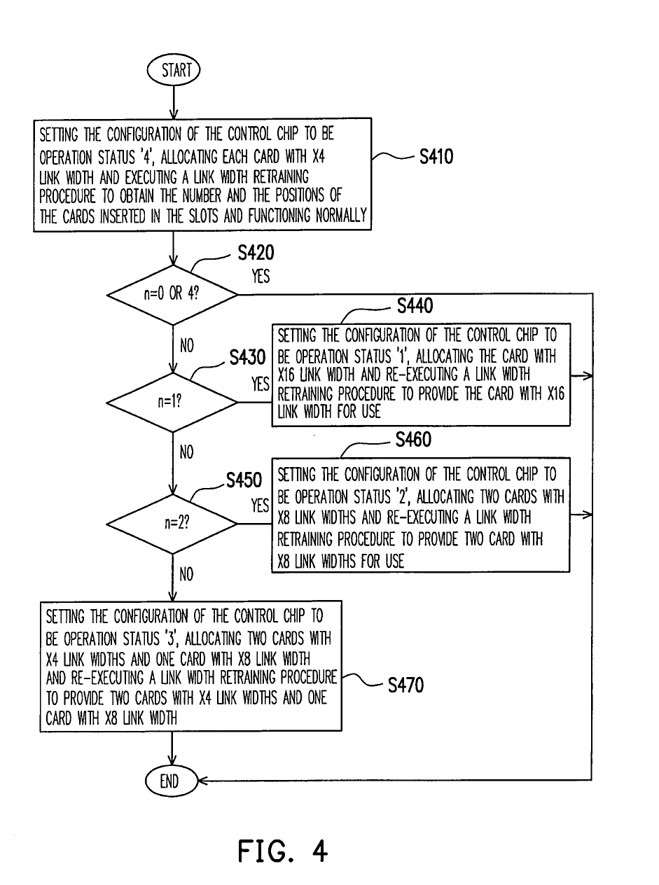

FIG. 4 is a flowchart of the method for dynamically allocating link width of a riser card according to the third embodiment of the present invention. Referring to FIG. 4, first, the configuration of the control chip is set by the system to be four cards in advance, and the link width allocated for each card to use is set to x4 link width. Next, ‘1’ is written to the link width retraining register of the control chip so as to execute a link width retraining procedure. Once the link width retraining procedure is completed, the link width retraining result can be obtained from the bridge status register of the control chip. Further, the number and the positions of the cards inserted in the slots and functioning normally are able to be obtained as well (step S410).

In more detail, four bridges corresponding to four slots on the riser card are employed and disposed at the control chip so as to provide proper link widths to the cards in the slots for use. The status registers on the bridges would record different values according to the link width retraining result. The record value is, for example, NULL, L5, L6, L7 and L8, wherein NULL means no ‘good’ card is inserted, and all of L5, L6, L7 and L8 mean a card is inserted in the slot, respectively and the inserted card functions normally.

Note that the above-mentioned retraining result includes recording whether or not each the slot connected by the corresponding bridge is inserted by a card, whether or not the inserted card functions normally and the information of the link width of the card. After obtaining the retraining result, the number and the positions of the ‘good’ cards are known. Assuming the number of the ‘good’ cards is n, wherein n is an integer between 0 and 4, the configuration of the control chip is set according to the n value, following by re-executing a link width retraining procedure. The flowcharts of optimizing link width corresponding to different n values according to the present invention are depicted.

In step S420, when the n value is ‘0’ or ‘4’, wherein ‘0’ means no ‘good’ card is inserted in all of the four slots and ‘4’ means all of the four slots are inserted by ‘good’ cards, since the previously executed link width retraining procedure in the embodiment is to set the configuration of the control chip to be four cards with x4 link width allocated to each the card, therefore, the original retraining result is adopted without re-executing a link width retraining procedure.

In step S430, when the n value is ‘1’ which means only one slot among the four slots is inserted by a ‘good’ card, the configuration of the control chip is set to be status ‘1’. Meanwhile, the hardware logic circuit of the multiplexer is planned to support a slot with x16 link width according to the retraining result and a link width retraining procedure is re-executed. After delaying a preset time, the link width retraining procedure is completed and the ‘good’ card is eligible to get the x16 link width to use (step S440).

In step S450, when the n value is ‘2’ which means only two slots among the four slots are inserted by ‘good’ cards, the configuration of the control chip is set to be status ‘2’. Meanwhile, the hardware logic circuit of the multiplexer is planned to support two slots with x8 link width according to the retraining result and a link width retraining procedure is re-executed. After delaying a preset time, the link width retraining procedure is completed and the two ‘good’ cards are respectively eligible to get the x8 link width to use (step S460).

In step S450, when the n value is ‘3’ which means three slots among the four slots are inserted by ‘good’ cards, the configuration of the control chip is set to be status ‘3’. Meanwhile, the hardware logic circuit of the multiplexer is planned to support two slots with x4 link width and a slot with x8 link width according to the retraining result and a link width retraining procedure is re-executed. After delaying a preset time, the link width retraining procedure is completed and the three ‘good’ cards are respectively eligible to get an x4 link width, an x4 link width and an x8 link width to use (step S470).

Note that for the n=3 case, one of the three cards is allocated by a x8 link width. In order to make the link width allocation optimal, the present invention further includes adjusting the hardware logic circuit of the multiplexer and repeating the link width retraining procedure until the optimal retraining result is obtained. To achieve the optimal result, two schemes are available as follows.

One scheme is that after each the link width retraining procedure is executed, it is immediately judged whether or not the link width retraining result is the optimal; if not, re-allocating the link width to each card and re-executing the link width retraining procedure until the retraining result is the optimal. Wherein, to judge whether or not a retraining result is the optimal, it needs to, for example, detect the card allocated by the x8 link width to find out whether or not the card supports the x8 link width; if yes, the retraining result is considered as the optimal result.

The other scheme is that after each the link width retraining procedure is executed, the retraining result is recorded. Then, the link width allocated to each card is modified one by one, the link width retraining procedure is re-executed until all the link width allocations are tested and an optimal retraining result is chosen to allocate a link width for each the card to use. The following table 1 is a definition table of the logic circuit according to the third embodiment of the present invention:

TABLE 1

| GPI4, | L5 | L6 | L7 | L8 |
|---|---|---|---|---|
| GPI3, | | | | |
| GPI2, | | | | |
| GPI1, | | | | |
| GPI0 | | | | |
| 00000 | L1 | L2 | L3 | L4 |
| 00001 | L1 + L2 + L3 + L4 | no | no | no |
| 00010 | no | L1 + L2 + L3 + L4 | no | no |
| 00100 | no | no | L1 + L2 + L3 + L4 | no |
| 01000 | no | no | no | L1 + L2 + L3 + L4 |
| 00011 | L1 + L2 | L3 + L4 | no | no |
| 00101 | L1 + L2 | no | L3 + L4 | no |
| 01001 | L1 + L2 | no | no | L3 + L4 |
| 01100 | no | L1 + L2 | L3 + L4 | no |
| 01010 | no | L1 + L2 | no | L3 + L4 |
| 01100 | no | no | L1 + L2 | L3 + L4 |
| 00111 | L3 | L4 | L1 + L2 | no |
| 01101 | L3 | no | L4 | L1 + L2 |
| 01011 | L3 | L4 | no | L1 + L2 |
| 01110 | no | L3 | L4 | L1 + L2 |
| 01111 | L1 | L2 | L3 | L4 |
| 10000 | L3 | L1 + L2 | L4 | no |
| 10001 | L1 + L2 | L3 | L4 | no |
| 10010 | L3 | no | L1 + L2 | L4 |
| 10011 | L1 + L2 | no | L3 | L4 |
| 10100 | L3 | L1 + L2 | no | L4 |
| 10101 | L1 + L2 | L3 | no | L4 |
| 10110 | no | L3 | L1 + L2 | L4 |
| 10111 | no | L1 + L2 | L3 | L4 |

By means of the setting of the general purpose input pins (GPI pins) in table 1, the hardware logic circuit of the multiplexer can be modified so as to provide different link widths for each card to use. After the link width retraining procedure is executed and completed, another optimal retraining result is chosen to allocate the link widths until the goal of dynamically allocating link width of a riser card provided by the present invention is achieved.

In summary, the method for dynamically allocating link width of a riser card of the present invent has at least following advantages:

1. By using the dynamically allocating link width approach, there is no limitation of slot number of the riser card and the types and the number of the inserted cards, which is able to provide an operation flexibility.

2. By adapting the scheme that appropriately modifying link widths allocated for each card to use according to the number and the positions of the cards is able to achieve the optimization of link widths, which significantly advances the system efficiency.

3. By using one riser card only instead of using various cards is able to save the design cost of the riser card and enhance the convenience to handle with the card.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for dynamically allocating link width of a riser card, suitable for a system comprising a riser card, wherein the riser card comprises a plurality of slots suitable for inserting in a plurality of cards, the method comprising:
a. detecting the number and the positions of at least a card inserted in the slots and functioning normally;
b. setting a configuration for a control chip of the system according to the number and the positions of the cards;
c. setting a link width to be allocated for each of the cards to use according to the configuration of the control chip; and
d. executing a link width retraining procedure so as to allocate each of the cards with the link width.

2. The method for dynamically allocating link width of a riser card according to claim 1, wherein the configuration of the control chip of the system comprises one of one card, two cards, three cards and four cards.

3. The method for dynamically allocating link width of a riser card according to claim 2, wherein the link width available for each of the cards to use comprises one of x1 link width, x4 link width, x8 link width and x16 link width.

4. The method for dynamically allocating link width of a riser card according to claim 3, wherein step a. comprises:
presetting the configuration to be four cards;
setting the link width allocated for each of the cards to use to x4 link width;
executing a link width retraining procedure; and
obtaining the number and the positions of the cards inserted in the slots and functioning normally according to a retraining result of the link width retraining procedure.

5. The method for dynamically allocating link width of a riser card according to claim 4, wherein the retraining result is recorded in a status register of a plurality of bridges of the control chip.

6. The method for dynamically allocating link width of a riser card according to claim 5, wherein the retraining result comprises whether or not the card is inserted in the slot connected to each of the bridge, whether or not the inserted card functions normally and the link width of the card.

7. The method for dynamically allocating link width of a riser card according to claim 3, wherein the step c comprises:
if the configuration is one card, the link width allocated for the card to use is set to one x16 link width.

8. The method for dynamically allocating link width of a riser card according to claim 3, wherein the step c comprises:
if the configuration is two cards, the link width allocated for each of the cards to use is set to two x8 link widths.

9. The method for dynamically allocating link width of a riser card according to claim 3, wherein the step c comprises:
if the configuration is three cards, the link width allocated for each of the cards to use is set to two x4 link widths and one x8 link width.

10. The method for dynamically allocating link width of a riser card according to claim 9, wherein after the step d. the method further comprises:
judging whether or not a retraining result of the link width retraining procedure is the optimal;
if the retraining result is not the optimal, modifying the link width allocated for each of the cards to use and re-executing a link width retraining procedure until the optimal retraining result is achieved.

11. The method for dynamically allocating link width of a riser card according to claim 9, wherein after the step d. the method further comprises:
recording a retraining result of the link width retraining,
modifying the link width allocated for each of the cards to use and re-executing a link width retraining procedure; and
selecting the optimal retraining result and executing the link width retraining procedure to allocate the link width for each of the cards to use.

12. The method for dynamically allocating link width of a riser card according to claim 1, wherein the manner of setting the configuration of the control chip of the system comprises:
setting a retraining register of the control chip to decide the configuration.

13. The method for dynamically allocating link width of a riser card according to claim 12, wherein the manner of executing the link width retraining procedure comprises:
setting the retraining register of the control chip to start up the link width retraining procedure.

14. The method for dynamically allocating link width of a riser card according to claim 13, wherein after starting up the link width retraining procedure, the method further comprises:
delaying a preset time for waiting for completing the link width retraining procedure.

15. The method for dynamically allocating link width of a riser card according to claim 1, wherein the manner of setting the link width to be allocated for each of the cards to use according to the configuration of the control chip comprises:
setting a plurality of pins of a logic circuit according to the configuration of the control chip;
connecting a plurality of bridges of the control chip to the slots through the logic circuit to provide the cards with the link width for use.

16. The method for dynamically allocating link width of a riser card according to claim 15, wherein the pins comprise general purpose input pins (GPI pins).

17. The method for dynamically allocating link width of a riser card according to claim 1, wherein the control chip is a north-bridge chip.

18. The method for dynamically allocating link width of a riser card according to claim 1, wherein the cards comprise peripheral component interconnect express cards (PCI-E cards).
